(19) United States
(12) Patent Application Publication
(10) Pub. No.: US 2020/0017050 A1
(43) Pub. Date: Jan. 16, 2020

(54) IMS-BASED FIRE RISK FACTOR NOTIFYING DEVICE AND METHOD IN INTERIOR VEHICLE ENVIRONMENT

(71) Applicant: LG Electronics Inc., Seoul (KR)

(72) Inventor: Hyunkyu KIM, Seoul (KR)

(21) Appl. No.: 16/557,980

(22) Filed: Aug. 30, 2019

(30) Foreign Application Priority Data
Aug. 20, 2019 (KR) 10-2019-0101915

(51) Int. Cl. B60R 21/015; G06K 9/00; A62C 3/07; G06Q 10/06

(52) U.S. Cl. CPC B60R 21/01534; B60R 21/01538; G06Q 10/0635; G06K 9/00335; A62C 3/07; G06K 9/00845

(57) ABSTRACT

The present invention relates to provide a fire risk factor notifying device and method in an interior vehicle environment based on an interior monitoring sensor (IMS) which may recognize objects which may cause a vehicle fire based on an IMS in an interior vehicle environment. According to the present invention, in the IMS-based fire risk factor notifying device and method in an interior vehicle environment, one or more of an autonomous vehicle and a server of the present invention may be associated with artificial intelligence (AI) modules, unmanned aerial vehicles (UAVs), robots, augmented reality (AR) devices, virtual reality (VR) devices, and 5G service-related devices.

### CROSS-REFERENCE TO RELATED APPLICATION

The present disclosure claims priority to and the benefit of Korean Patent Application No. 10-2019-0101915, filed on Aug. 20, 2019, the disclosure of which is incorporated herein by reference in its entirety.

### BACKGROUND

### 1. Field of the Invention

The present invention relates to devices and methods for previously notifying a user of a fire risk factor based on an interior monitoring sensor (IMS), with fire factors and risk types identified from among objects.

### 2. Description of Related Art

With vehicles increasing every year, vehicle fires are also on the rise and are threatening drivers' and passengers' safety.

A vehicle fire may be caused by a car accident or defects in the electric devices, fuel feeder or igniter in the engine. Unless suppressed at its early stage, the fire may burn down the vehicle or spread to other nearby cars.

As auto industry grows, more and more vehicles are adopting always-on electric devices, such as hybrid brake system (HBS), brake-by-wire (BbW), electro-mechanical brake (EMB), anti-lock brake system (ABS), electronic stability control (ESC), and electronic parking brake (EPB). Defects in the electric devices result in more likelihood of spontaneous combustion inside the engine room. For vehicle fires, early suppression is critical to preventing loss of human lives and property.

Most of vehicles now in the market lack an automatic extinguishing device, and some drivers are carrying a portable extinguisher in their vehicle to prepare for fires.

However, if a fire breaks out in the vehicle, the driver or passenger is required to put out the fire on their own using the extinguisher. This way is not only inconvenient but also fails to respond quickly to the fire. With no extinguisher equipped in the vehicle, fire suppression would be a very tricky task.

Korean Patent No. 10-0191957 registered on Jan. 27, 1999 discloses a device capable of automatically detecting a vehicle fire and toxic gases and suppressing the fire.

FIG. 1 illustrates the configuration of an extinguishing device installed in a vehicle according to the prior art.

Referring to FIG. 1, an extinguishing device includes a power case 40 containing an extinguishing powder which is mounted near the roof rail 30 fitted to the head lining 20 and the roof panel 10 of a vehicle.

A check valve 50 is provided at the outlet 42 of the powder case 40 and is operated by a driving motor 55 provided near the powder case 40 to open or close the outlet 42. A fire sensor 60 is provided on the surface of the head lining 20, which is positioned near the powder case 40, to detect a fire and toxic gases and transmit the resultant signal to a computing unit 70.

The computing unit 70 receives the signals from the fire sensor 60, compares and analyzes the signal, and controls the driving motor 55 to thereby operate the check valve 50.

In the conventional extinguishing device, if a vehicle fire breaks out, the fire sensor immediately detects the fire and sends the signal to the computing unit (ECU) 70. The computing unit 70 compares and analyzes the signal and, if it is a preset value or more, opens the check valve of the powder case to allow the extinguishing powder to automatically jet to the inside of the vehicle, thereby quickly suppressing the fire.

As such, such an extinguishing device may respond to vehicle fires which have already broken out but cannot prevent a fire. In other words, the conventional device cannot take any preventative measure to fires.

Further, such conventional car extinguishers cannot identify objects which may cause a fire before a fire breaks out. Information about such objects is not shared with the driver and passengers.

Further, the conventional device requires the fire sensor. The fire sensor needs to be additionally installed inside the vehicle.

Autonomous vehicles recently under development may easily distract passengers from driving, e.g., because their self-driving functionality allows passengers to play games or do work while driving. Thus, fires in driverless cars may not be rapidly perceived. In other words, autonomous cars may be vulnerable to vehicle fires.

### SUMMARY OF THE INVENTION

An object of the present invention is to provide a fire risk factor notifying device and method based on an interior monitoring sensor (IMS) in an interior vehicle environment, which may recognize objects which may cause a vehicle fire based on an IMS in an interior vehicle environment.

Another object of the present invention is to provide a fire risk factor notifying device and method based on an IMS in an interior vehicle environment which may recognize a passenger's behavior based on an IMS in an interior vehicle environment.

Another object of the present invention is to provide a fire risk factor notifying device and method based on an IMS in an interior vehicle environment which may notify the passenger of objects which may cause a vehicle fire before a vehicle fire breaks out in an interior vehicle environment.

Another object of the present invention is to provide a fire risk factor notifying device and method based on an IMS in an interior vehicle environment which may determine the risk grade of a vehicle fire according to objects which may cause a vehicle fire and the passenger's behavior.

Another object of the present invention is to provide a fire risk factor notifying device and method based on an IMS in an interior vehicle environment which may transfer the risk grade of the vehicle fire via a device capable of transferring visible or audible information in the vehicle.

Another object of the present invention is to provide a fire risk factor notifying device and method based on an IMS in an interior vehicle environment which may allow the passenger to take a proper action depending on the risk grade of the vehicle fire.

The present invention is not limited to the foregoing objectives, but other objects and advantages will be readily appreciated and apparent from the following detailed description of embodiments of the present invention. It will also be appreciated that the objects and advantages of the present invention may be achieved by the means shown in the claims and combinations thereof.

According to the present invention, the fire risk factor notifying device and method based on an IMS in an interior vehicle environment may identify fire factors and risk types among objects based on an IMS and, if a risk is predicted, activate target object monitoring and suppression control.

According to the present invention, the fire risk factor notifying device and method based on an IMS in an interior vehicle environment may recognize objects which may cause a vehicle fire in an interior vehicle environment based on an IMS.

According to the present invention, the fire risk factor notifying device and method based on an IMS in an interior vehicle environment may recognize the passenger's behavior based on an IMS in an interior vehicle environment.

According to the present invention, the fire risk factor notifying device and method based on an IMS in an interior vehicle environment may previously notify the passenger of objects which may cause a fire in an interior vehicle environment.

According to the present invention, the fire risk factor notifying device and method based on an IMS in an interior vehicle environment may determine the risk grade of a vehicle fire depending on the passenger's behavior and objects which may cause a vehicle fire in an interior vehicle environment.

According to the present invention, the fire risk factor notifying device and method based on an IMS in an interior vehicle environment may transfer the vehicle fire risk grade to the passenger via a device capable of transferring visible and audible information in the vehicle.

According to the present invention, the fire risk factor notifying device and method based on an IMS in an interior vehicle environment may allow the passenger to take a proper action depending on the fire risk grade.

According to the present invention, a fire risk factor notifying device may comprise a monitoring unit monitoring an interior environment of a vehicle based on an image obtained from an interior monitoring sensor (IMS), an object recognizing unit recognizing a second object which may cause a car vehicle identified based on object learning data among first objects monitored in the interior vehicle environment, a behavior recognizing unit recognizing a passenger's behavior monitored in the interior vehicle environment, a grade determining unit determining a risk grade of a vehicle fire based on a combination of the second object and the passenger's behavior, and a notification processing unit transferring the determined risk grade to the passenger via a device capable of transferring visible or audible information in the vehicle.

According to the present invention, a fire risk factor notifying method may comprise monitoring an interior environment of a vehicle based on an image obtained by an interior monitoring sensor (IMS) using a monitoring unit, recognizing, using an object recognizing unit, a second object which may cause a vehicle fire identified based on object learning data among first objects monitored in the interior vehicle environment, recognizing, using a behavior recognizing unit, a passenger behavior based on the monitored interior vehicle environment, determining, using a grade determining unit, a risk grade of a vehicle fire based on a combination of the second object and the passenger's behavior, and transferring, using a notification processing unit, the determined risk grade to the passenger via a device capable of transferring visible or audible information in the vehicle.

According to the present invention, the fire risk factor notifying device and method based on an IMS in an interior vehicle environment may recognize objects which may cause a vehicle fire in an interior vehicle environment based on an IMS.

According to the present invention, the fire risk factor notifying device and method based on an IMS in an interior vehicle environment may recognize the passenger's behavior based on an IMS in an interior vehicle environment.

According to the present invention, the fire risk factor notifying device and method based on an IMS in an interior vehicle environment may previously notify the passenger of objects which may cause a fire in an interior vehicle environment before a vehicle fire breaks out.

According to the present invention, the fire risk factor notifying device and method based on an IMS in an interior vehicle environment may determine the risk grade of a vehicle fire depending on the passenger's behavior and objects which may cause a vehicle fire in an interior vehicle environment.

According to the present invention, the fire risk factor notifying device and method based on an IMS in an interior vehicle environment may transfer the vehicle fire risk grade to the passenger via a device capable of transferring visible and audible information in the vehicle.

According to the present invention, the fire risk factor notifying device and method based on an IMS in an interior vehicle environment may allow the passenger to take a proper action depending on the fire risk grade.

The foregoing or other specific effects of the present invention are described below in conjunction with the following detailed description of the present invention.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 illustrates the configuration of an extinguishing device installed in a vehicle according to the prior art;

FIG. 2 is a block diagram illustrating a configuration of a fire risk factor notifying device 100 based on an IMS in an interior vehicle environment according to an embodiment of the present invention;

FIG. 3 is a view illustrating a configuration for describing a process of obtaining interior environment information based on the IMS of FIG. 2;

FIG. 4 is a block diagram illustrating an AI device according to an embodiment of the present invention;

FIG. 5 is a block diagram illustrating an AI server according to an embodiment of the present invention;

FIG. 6 is a block diagram illustrating an AI system according to an embodiment of the present invention;

FIG. 7 is a flowchart illustrating a fire risk factor notifying method based on an IMS in an interior vehicle environment according to an embodiment of the present invention;

FIG. 8 is a detailed flowchart illustrating the step of recognizing the second object and the presence or absence of a fire inside the vehicle as shown in FIG. 7; and

FIG. 9 is a detailed flowchart illustrating the step of determining the risk grade of a vehicle fire as shown in FIG. 7.

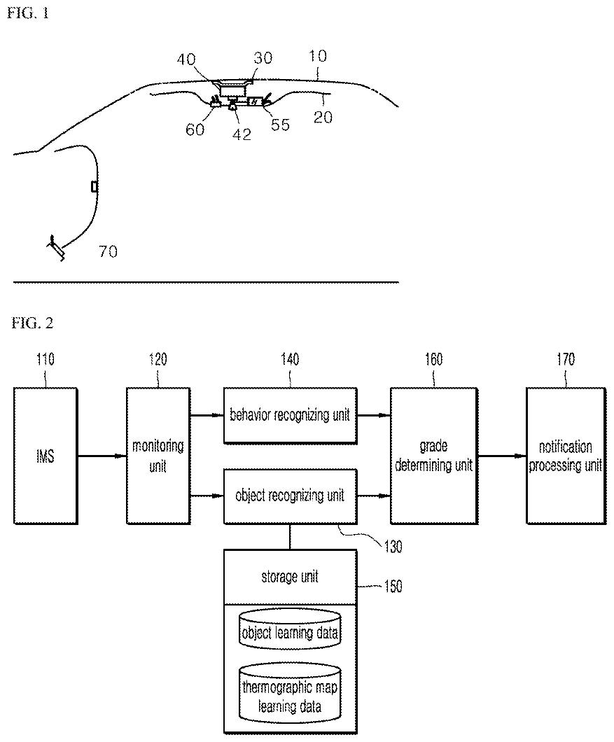

### DETAILED DESCRIPTION OF EXEMPLARY EMBODIMENTS

The foregoing objectives, features, and advantages are described below in detail with reference to the accompanying drawings so that the technical spirit of the present invention may easily be achieved by one of ordinary skill in the art to which the invention pertains. When determined to make the subject matter of the present invention unclear, the detailed description of the known art or functions may be skipped. Hereinafter, preferred embodiments of the present invention are described in detail with reference to the accompanying drawings. The same reference denotations are used to refer to the same or similar elements throughout the drawings.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

Hereinafter, a fire risk factor notifying device and method based on an IMS in an interior vehicle environment is described with reference to some embodiments of the present invention.

FIG. 2 is a block diagram illustrating a configuration of a fire risk factor notifying device 100 based on an IMS in an interior vehicle environment according to an embodiment of the present invention. The fire risk factor notifying device 100 based on an IMS in an interior vehicle environment as shown in FIG. 2 is merely an example, and the components thereof are not limited to those shown in FIG. 2 but, as necessary, more components may be added or some components may be modified or deleted therefrom.

As shown in FIG. 2, according to the present invention, the fire risk factor notifying device 100 may include an interior monitoring sensor (IMS) 110, a monitoring unit 120, an object recognizing unit 130, a behavior recognizing unit 140, a storage unit 150, a grade determining unit 160, and a notification processing unit 170.

The IMS 110 obtains images of the inside of the vehicle. The obtained images may include infrared radiation (IR) images or thermographic images. To that end, there may be included an IR camera capturing IR images using a charge-coupled device (CCD) or a thermographic camera capturing thermographic images which are represented as temperatures using heat.

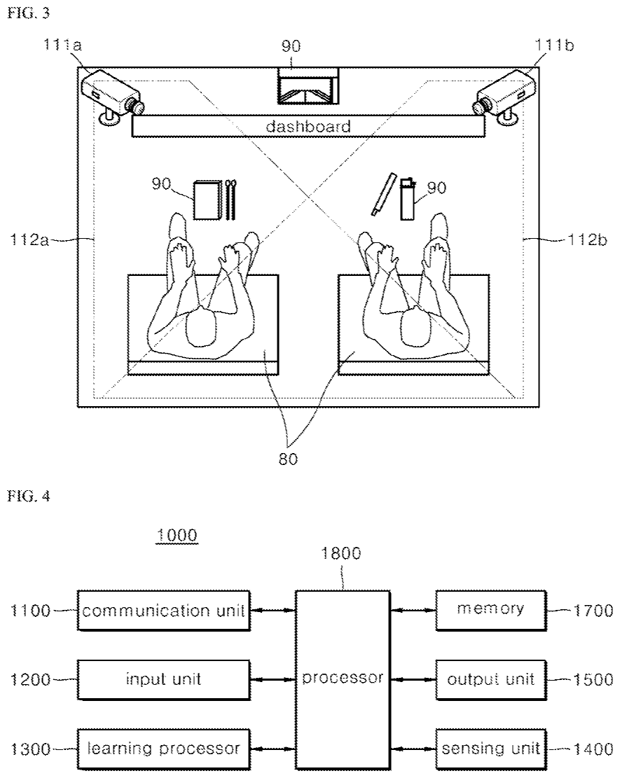

FIG. 3 is a view illustrating a configuration for describing a process of obtaining interior environment information based on the IMS of FIG. 2.

As shown in FIG. 3, the IMS 110 obtains IR images or thermographic images using cameras 111a and 111b installed in the interior of the vehicle.

The cameras 111a and 111b may have limited image capturing ranges 112a and 112b and be at least one or more cameras which enable image capturing or recording at different angles. The cameras 111a and 111b may capture IR images or thermographic images of things 90 including lighters, matches, or cigarettes placed in the interior of the vehicle and electronic devices installed in the interior of the vehicle, as well as a passenger 80 inside the vehicle.

The monitoring unit 120 monitors the interior vehicle environment based on the IR images and thermographic images obtained by the IMS 110. The interior vehicle environment may include first objects including electronic devices installed in the interior of the vehicle and things placed inside the vehicle and the movements, actions, or gestures of the passenger in the vehicle. The interior vehicle environment may also include a thermographic image map including the thermographic images of the interior of the vehicle.

The object recognizing unit 130 may identify fire factors and risk types from among the first objects monitored by the monitoring unit 120, thereby recognizing second objects which may cause a vehicle fire. The second objects which may cause a vehicle fire may include electronic devices, e.g., a navigation and black box, installed in the interior of the vehicle, lighters, matches, or cigarettes.

The object recognizing unit measures the temperature of the thermographic image based on the thermographic image map monitored in the monitoring unit 120 and recognizes the presence or absence of a fire inside the vehicle.

The object recognizing unit may recognize the second objects and the presence or absence of a fire based on object learning data and thermographic map learning data stored in the storage unit 150. The object learning data and the thermographic map learning data may be learned in an object model using deep neutral networks (DNN) training.

The behavior recognizing unit 140 recognizes the passenger's behavior monitored in the monitoring unit 120 and determines whether the passenger's behavior is related to the second object or the thermographic image map in association with the second object and thermographic image map. For example, if the passenger's behavior is moving the second object or removing the area of the thermographic image map, the behavior recognizing unit 140 determine that they are related to each other.

The grade determining unit 160 determines the risk grade of a vehicle fire based on a combination of the second object and the presence or absence of a fire, which are recognized by the object recognizing unit 130, and the passenger's behavior recognized by the behavior recognizing unit 140. The risk grade may come in various levels, e.g., safe, normal, warning, and danger. The risk grade is not limited thereto and changes may be made to the levels.

The notification processing unit 170 transfers, as a notification service, the risk grade determined by the grade determining unit 160 to the passenger via a device including a display capable of transferring visible information or a speaker capable of transferring audible information in the vehicle.

The passenger may take a proper action according to the vehicle fire risk grade transferred via the device.

The fire risk factor notifying device (100)-equipped vehicle may be an autonomous vehicle. The autonomous vehicle may be associated with any artificial intelligence (AI) modules, drones, unmanned aerial vehicles, robots, augmented reality (AR) modules, virtual reality (VR) modules, or 5th generation (5G) mobile communication devices.

Artificial intelligence (AI) means machine intelligence or methodology for implementing the same. Machine learning means methodology for defining and addressing various issues treated in the artificial intelligence sector. Machine learning is oftentimes defined as an algorithm for raising the efficiency of tasks based on continuous experiences for the tasks.

Artificial neural networks (ANNs) are models used in machine learning and may mean all models which are constituted of artificial neurons (nodes) forming networks and are able to solve problems. An ANN may be defined by a connection pattern between other layers of neurons, a learning process of updating model parameters, and an activation function for generating output.

An ANN may include an input layer, an output layer, and selectively one or more hidden layers. Each layer includes one or more neurons, and the ANN may include synapses connecting the neurons. In the ANN, each neuron may output input signals entered via the synapses, weights, and values of the activation function for deviations.

Model parameters mean parameters determined by learning and include weights of synapse connections and neuron deviations. Hyperparameters mean parameters which need to be set before learning in a machine learning algorithm and include, e.g., learning rate, repetition count, mini-batch size, and initialization function.

ANN learning may aim to determine model parameters which minimize a loss function. The loss function may be used as an index for determining the optimal model parameters in the ANN learning process.

Machine learning may be divided into supervised learning, unsupervised learning, and reinforcement learning depending on learning schemes.

Supervised learning means a method of training an ANN with a label for learning data given. The label may mean a correct answer (or resultant value) that the ANN needs to infer when the learning data is input to the ANN. Unsupervised learning may mean a method of training the ANN with no label for learning data. Reinforcement learning may mean a training method by which an agent defined in a certain environment may select the behavior or behavior order in which the cumulative compensation is maximized.

Machine learning implemented by a deep neural network (DNN), which includes a plurality of hidden layers among ANNs, is also called deep learning, and deep learning is part of machine learning. Hereinafter, machine learning includes deep learning.

Robot may mean a machine which automatically processes or operates a given task on its own capability. Among others, robots which determine the environment and determine and operate on their own may be called intelligent robots.

Robots may be classified into industrial robots, medical robots, home robots, and military robots depending on purposes or use sectors.

A robot includes driving units including actuators or motors and perform various physical operations, e.g., as do robot joints. A movable robot may include wheels, brakes, or propellers in the driving units and drive on roads or fly in the air by way of the driving units.

Autonomous driving means self-driving technology, and autonomous driving vehicle means a vehicle driving with a user's no or minimum control.

For example, autonomous driving may encompass all of such techniques as staying in a driving lane, automatic speed control, e.g., adaptive cruise control, autonomous driving along a predetermined route, and automatically setting a route and directing to a destination when the display is set.

The vehicle may collectively denote not only a vehicle with only an internal combustion engine, a hybrid vehicle with both an internal combustion engine and an electric motor, and an electric vehicle with only an electric motor, but also a train or motorcycle.

The autonomous vehicle may be regarded as a robot capable of autonomous driving.

XR collectively refers to virtual reality (VR), augmented reality (AR), and mixed reality (MR). VR is computer graphics technology that provides the real-world objects or background in a computer graphics (CG) image. AR provides a virtual CG image overlaid on a real-world object image, along with the real-world object image. MR mixes and provides the real-world with virtual objects.

MR is similar to AR in that it provides the real-world objects together with virtual objects. However, while AR takes virtual objects as supplementing real-world objects, MR treats virtual objects and real-world objects equally.

XR technology may apply to, e.g., head-mount displays (HMDs), head-up displays (HUDs), mobile phones, table PCs, laptop computers, desktop computers, TVs, or digital signage, and XR technology-applied devices may be called XR devices.

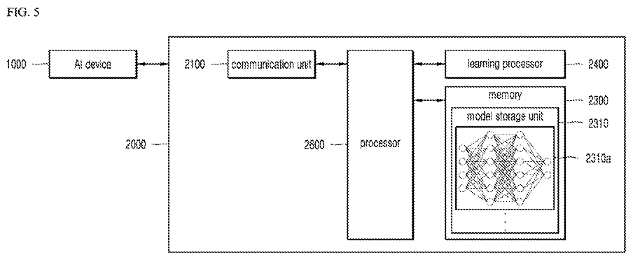

FIG. 4 is a block diagram illustrating an AI device according to an embodiment of the present invention. FIG. 5 is a block diagram illustrating an AI server according to an embodiment of the present invention.

Referring to FIGS. 4 and 5, an AI device 1000 may be implemented as a stationary or mobile device, such as a TV projector, mobile phone, smartphone, desktop computer, laptop computer, digital broadcast terminal, personal digital assistant (PDA), portable multimedia player (PMP), navigation, tablet PC, wearable device, settop box (STB), DMB receiver, radio, washer, refrigerator, digital signage, robot, or vehicle.

Referring to FIG. 4, the AI device 1000 may include, e.g., a communication unit 1100, an input unit 1200, a learning processor 1300, a sensing unit 1400, an output unit 1500, a memory 1700, and a processor 1800.

The communication unit 1100 may transmit and receive data to/from external devices, e.g., other AI devices or AI servers, via wired/wireless communication technology. For example, the communication unit 1100 may transmit and receive, e.g., sensor information, user input, learning models, and control signals, to/from external devices.

The communication module 1100 may use various communication schemes, such as global system for mobile communication (GSM), code division multiple access (CDMA), long-term evolution (LTE), 5th generation (5G), wireless local area network (WLAN), wireless-fidelity (Wi-Fi), Bluetooth™, radio frequency identification (RFID), infrared data association (IrDA), ZigBee, or near field communication (NFC).

The input unit 1200 may obtain various types of data.

The input unit 1200 may include a camera for inputting image signals, a microphone for receiving audio signals, and a user input unit for receiving information from the user. The camera or microphone may be taken as a sensor, and a signal obtained by the camera or microphone may be referred to as sensing data or sensor information.

The input unit 1200 may obtain input data which is to be used when obtaining output using a learning model and learning data for model learning. The input unit 1200 may obtain unprocessed input data in which case the processor 1800 or learning processor 1300 may extract input features by pre-processing the input data.

The learning processor 1300 may train a model constituted of an ANN using learning data. The trained ANN may be referred to as a learning model. The learning model may be used to infer resultant values for new input data, rather than learning data, and the inferred values may be used as a basis for determining a certain operation.

The learning processor 1300, together with the learning processor 2400 of the AI server 2000, may perform AI processing.

The learning processor 1300 may include a memory which is integrated with, or implemented in, the AI device 1000. The memory 1700 of the learning processor 1300 may be implemented as an external memory directly coupled with the AI device 1000 or a memory retained in an external device.

The sensing unit 1400 may obtain at least one of internal information of the AI device 1000, ambient environment information of the AI device 1000, and user information via various sensors.

The sensing unit 1400 may include, e.g., a proximity sensor, an illuminance sensor, an acceleration sensor, a magnetic sensor, a gyro sensor, an inertia sensor, a red-green-blue (RGB) sensor, an infrared (IR) sensor, a fingerprint recognition sensor, an ultrasonic sensor, a light sensor, a microphone, a lidar, or radar.

The output unit 1500 may generate output related to visual sense, auditory sense, or tactile sense.

The output unit 1500 may include a display unit for outputting visual information, a speaker for outputting auditory information, and a haptic module for outputting tactile information.

The memory 1700 may store data which supports various functions of the AI device 1000. For example, the memory 1700 may store, e.g., input data obtained from the input unit 1200, learning data, learning model, and learning history.

The processor 1800 may determine at least one executable operation of the AI device 1000 based on information determined or generated by a data analysis algorithm or a machine learning algorithm. The processor 1800 may control the components of the AI device 1000 to perform the determined operation.

To that end, the processor 1800 may request, retrieve, receive, or use data of the memory 1700 or learning processor 1300 and control the components of the AI device 1000 to execute an operation, predicted or determined to be preferred, among the at least one executable operation.

When needing an association with an external device to perform the determined operation, the processor 1800 may generate a control signal for controlling the external device and transmit the generated control signal to the external device.

The processor 1800 may obtain intent information for the user input and determine the user's requirement based on the obtained intent information.

The processor 1800 may obtain the intent information corresponding to the user input using at least one or more of a speech-to-text (STT) engine for converting voice input into a text string or a natural language processing (NLP) engine for obtaining intent information in natural language.

At least one or more of the STT engine or the NLP engine may be, at least partially, constituted as an ANN trained by a machine learning algorithm. At least one or more of the STT engine or the NLP engine may be trained by the learning processor 1300, the learning processor 2400 of the AI server 2000, or distributed processing thereof.

The processor 1800 may gather history information including, e.g., the content of the operation of the AI device 1000 or the user's feedback for the operation and store the gathered history information in the memory 1700 or the learning processor 1300 or transmit the gathered history information to an external device, e.g., the AI server 2000. The gathered history information may be used to update the learning model.

The processor 1800 may control at least some of the components of the AI device 1000 to drive an application program stored in the memory 1700. The processor 1800 may operate two or more of the components of the AI device 1000, with the two or more components combined together, so as to drive the application program.

Referring to FIGS. 4 and 5, the AI server 2000 may mean a device which trains the ANN using a machine learning algorithm or uses the trained ANN. The AI server 2000 may be constituted of a plurality of servers for distributed processing and may be defined as a 5G network. The AI server 2000 may be included, as a component of the AI device 1000, in the AI device 1000 and may, along with the AI device 1000, perform at least part of the AI processing.

The AI server 2000 may include a communication unit 2100, a memory 2300, a learning processor 2400, and a processor 2600.

The communication unit 2100 may transmit and receive data to/from an external device, e.g., the AI device 1000.

The memory 2300 may include a model storage unit 2310. The model storage unit 2310 may store a model (or ANN 231a) which is being trained or has been trained by the learning processor 2400.

The learning processor 2400 may train the ANN 2310a using learning data. The learning model may be equipped and used in the AI server 2000 or may be equipped and used in an external device, e.g., the AI device 1000.

The learning model may be implemented in hardware, software, or a combination thereof. When the whole or part of the learning model is implemented in software, one or more instructions constituting the learning model may be stored in the memory 2300.

The processor 2600 may infer a resultant value for new input data using the learning model and generate a response or control command based on the inferred resultant value.

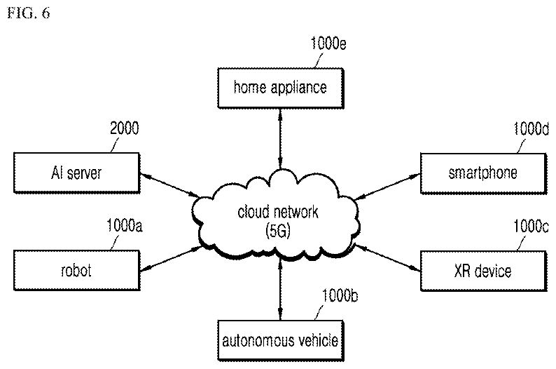

FIG. 6 is a block diagram illustrating an AI system according to an embodiment of the present invention.

Referring to FIG. 6, in an AI system, at least one or more of a an AI server 2000, a robot 1000a, an autonomous vehicle 1000b, an XR device 1000c, a smartphone 1000d, or a home appliance 1000e are connected to a cloud network. The AI technology-applied robot 1000a, autonomous vehicle 1000b, XR device 1000c, smartphone 1000d, or home appliance 1000e may be referred to as an AI device 1000a to 1000e.

The cloud network may mean a network which constitutes part of a cloud computing infrastructure or is present in a cloud computing infrastructure. The cloud network may be configured as a 3G network, 4G network, a long-term evolution (LTE) network, or 5G network.

In other words, the devices 1000a to 1000e and 2000 constituting the AI system may be connected together via the cloud network. The devices 1000a to 1000e and 2000 may communicate with one another via base stations or without relying on a base station.

The AI server 2000 may include a server for performing AI processing and a server for performing computation on bigdata.

The AI server 2000 may be connected, via the cloud network, with at least one or more of the robot 1000a, the autonomous vehicle 1000b, the XR device 1000c, the smartphone 1000d, or the home appliance 1000e which are AI devices constituting the AI system and may assist in AI processing of at least some of the connected AI devices 1000a to 1000e.

The AI server 2000 may train an ANN according to a machine learning algorithm, on behalf of the AI devices 1000a to 1000e and may directly store a learning model or transfer the learning model to the AI devices 1000a to 1000e.

The AI server 2000 may receive input data from the AI devices 1000a to 1000e, infer a resultant value for the received input data using the learning model, generate a control command or response based on the inferred resultant value, and transmit the response or control command to the AI devices 1000a to 1000e.

The AI devices 1000a to 1000e themselves may infer resultant values for the input data using the learning model and generate responses or control commands based on the inferred resultant values.

Various embodiments of the AI devices 1000a to 1000e adopting the above-described technology are described below. The AI devices 1000a to 1000e shown in FIG. 6 may be specific examples of the AI device 1000 of FIG. 4.

The robot 1000a may adopt AI technology and may be implemented as a guider robot, a transportation robot, a robot vacuum, a wearable robot, an entertainment robot, a robot pet, or an unmanned aerial robot.

The robot 1000a may include a robot control module for controlling the operation, and the robot control module may mean a software module or a hardware chip in which the software module is implemented.

The robot 1000a may obtain status information about the robot 1000a using sensor information obtained from various kinds of sensors, detect (recognize) the ambient environment and objects, generate map data, determine a driving route and schedule, determine a response to the user's interaction, or determine operations.

The robot 1000a may use sensor information obtained from at least one or more sensors among a lidar, radar, and camera so as to determine a driving route and schedule.

The robot 1000a may perform the above-mentioned operations using a learning model constituted of at least one or more ANNs. For example, the robot 1000a may recognize the ambient environment and objects using the learning model and determine operations using the recognized ambient environment information or object information. The learning model may be learned directly by the robot 1000a or by an external device, e.g., the AI server 2000.

The robot 1000a itself may generate a result using the learning model to thereby perform an operation or the robot 1000a may transmit sensor information to an external device, e.g., the AI server 2000, receive a result generated by the external device and perform an operation.

The robot 1000a may determine a driving route and schedule using at least one or more of object information detected from the sensor information or object information obtained from the external device and control the driving unit to drive the robot 1000a according to the determined driving route and schedule.

The map data include object identification information about various objects placed in the space where the robot 1000a travels. For example, the map data may include identification information about stationary objects, e.g., walls and doors, and movable objects, e.g., pots and desks. The object identification information may include names, kinds, distances, and locations.

The robot 1000a may control the driving unit based on the user's control/interaction to thereby perform an operation or drive. The robot 1000a may obtain intent information about the interaction according to the user's motion or voice utterance, determine a response based on the obtained intent information, and perform an operation.

The autonomous vehicle 1000b may adopt AI technology and may be implemented as a mobile robot, vehicle, or unmanned aerial vehicle (UAV).

The autonomous vehicle 1000b may include an autonomous driving control module for controlling autonomous driving functions, and the autonomous driving control module may mean a software module or a hardware chip in which the software module is implemented. The autonomous driving control module may be included, as a component of the autonomous vehicle 1000b, in the autonomous vehicle 1000b or may be configured as a separate hardware device outside the autonomous vehicle 1000b and be connected with the autonomous vehicle 1000b.

The autonomous vehicle 1000b may obtain status information about the autonomous vehicle 1000b using sensor information obtained from various kinds of sensors, detect (recognize) the ambient environment and objects, generate map data, determine a driving route and schedule, or determine operations.

The autonomous vehicle 1000b may use sensor information obtained from at least one or more sensors among a lidar, radar, and camera so as to determine a driving route and schedule as does the robot 1000a.

The autonomous vehicle 1000b may recognize the environment of, or objects in an area where the view is blocked or an area away in a predetermined distance or more by receiving sensor information from external devices or may receive recognized information directly from the external devices.

The autonomous vehicle 1000b may perform the above-mentioned operations using a learning model constituted of at least one or more ANNs. For example, the autonomous vehicle 1000b may recognize the ambient environment and objects using the learning model and determine a driving route using the recognized ambient environment information or object information. The learning model may be learned directly by the autonomous vehicle 1000b or by an external device, e.g., the AI server 2000.

The autonomous vehicle 1000b itself may generate a result using the learning model to thereby perform an operation or the autonomous vehicle 1000b may transmit sensor information to an external device, e.g., the AI server 2000, receive a result generated by the external device and perform an operation.

The autonomous vehicle 1000b may determine a driving route and schedule using at least one or more of object information detected from the sensor information or object information obtained from the external device and control the driving unit to drive the autonomous vehicle 1000b according to the determined driving route and schedule.

The map data include object identification information about various objects placed in the space where the autonomous vehicle 1000b drives. For example, the map data may include identification information about stationary objects, e.g., streetlights, rocks, or buildings, and movable objects, e.g., vehicles or pedestrians. The object identification information may include names, kinds, distances, and locations.

The autonomous vehicle 1000b may control the driving unit based on the user's control/interaction to thereby perform an operation or drive. The autonomous vehicle 1000b may obtain intent information about the interaction according to the user's motion or voice utterance, determine a response based on the obtained intent information, and perform an operation.

The XR device 1000c may adopt AI technology and may be implemented as a head-mount display (HMD), a head-up display (HUD) equipped in a vehicle, a television, a mobile phone, a smartphone, a computer, a wearable device, a home appliance, digital signage, a vehicle, a stationary robot, or a movable robot.

The XR device 1000c may analyze three-dimensional (3D) point cloud data or image data obtained from an external device or via various sensors and generate location data and property data about 3D points, thereby obtaining information about the ambient environment or real-world objects and rendering and outputting XR objects. For example, the XR device 1000c may match an XR object including additional information about a recognized battery to the recognized object and output the resultant XR object.

The XR device 1000c may perform the above-mentioned operations using a learning model constituted of at least one or more ANNs. For example, the XR device 1000c may recognize a real-world object from the 3D point cloud data or image data using the learning model and provide information corresponding to the recognized real-world object. The learning model may be learned directly by the XR device 1000c or by an external device, e.g., the AI server 2000.

The XR device 1000c itself may generate a result using the learning model to thereby perform an operation or the XR device 1000c may transmit sensor information to an external device, e.g., the AI server 2000, receive a result generated by the external device and perform an operation.

The robot 1000a may adopt AI technology and autonomous driving technology and may be implemented as a guider robot, a transportation robot, a robot vacuum, a wearable robot, an entertainment robot, a robot pet, or an unmanned aerial robot.

The AI technology and autonomous driving technology-adopted robot 1000a may mean an autonomous drivable robot or the robot 1000a interacting with the autonomous vehicle 1000b.

The autonomous drivable robot 1000a may refer to any device which may travel on its own along a given driving route even without the user's control or itself determine and travel a driving route.

The autonomous drivable robot 1000a and the autonomous vehicle 1000b may use a common sensing method to determine one or more of a driving route or driving schedule. For example, the autonomous drivable robot 1000a and the autonomous vehicle 1000b may determine one or more of a driving route or a driving schedule using information sensed by a lidar, radar, or camera.

The robot 1000a interacting with the autonomous vehicle 1000b may be present separately from the autonomous vehicle 1000b and perform operations associated with the autonomous driving function inside or outside the autonomous vehicle 1000b or associated with the user aboard the autonomous vehicle 1000b.

The robot 1000a interacting with the autonomous vehicle 1000b, on behalf of the autonomous vehicle 1000b, may obtain sensor information and provide the sensor information to the autonomous vehicle 1000b, or the robot 1000a may obtain sensor information, generate ambient environment information or object information, and provide the ambient environment information or object information to the autonomous vehicle 1000b, thereby controlling or assisting in the autonomous driving function of the autonomous vehicle 1000b.

The robot 1000a interacting with the autonomous vehicle 1000b may monitor the user aboard the autonomous vehicle 1000b or control the functions of the autonomous vehicle 1000b via interactions with the user. For example, when the driver is determined to node off, the robot 1000a may activate the autonomous driving function of the autonomous vehicle 1000b or assist in the control of the driving unit of the autonomous vehicle 1000b. The functions of the autonomous vehicle 1000b, controlled by the robot 1000a, may include not merely the autonomous driving function but also the functions which the navigation system or audio system in the autonomous vehicle 1000b provide.

The robot 1000a interacting with the autonomous vehicle 1000b may provide information to the autonomous vehicle 1000b outside the autonomous vehicle 1000b or may assist in the functions of the autonomous vehicle 1000b. For example, the robot 1000a may provide traffic information including signal information to the autonomous vehicle 1000b, e.g., as does a smart traffic light, or may interact with the autonomous vehicle 1000b to automatically connect an electric charger to the charging port, e.g., as does an auto-electric charger of electric vehicle.

The robot 1000a may adopt AI technology and XR technology and may be implemented as a guider robot, a transportation robot, a robot vacuum, a wearable robot, an entertainment robot, a robot pet, an unmanned aerial robot, or a drone.

The XR technology-adopted robot 1000a may mean a robot targeted for control/interaction in an XR image. In this case, the robot 1000a may be distinguished from the XR device 1000c and they may interact with each other.

When the robot 1000a targeted for control/interaction in the XR image obtains sensor information from sensors including a camera, the robot 1000a or the XR device 1000c may generate an XR image based on the sensor information, and the XR device 1000c may output the generated XR image. The robot 1000a may be operated based on the user's interactions or control signals received via the XR device 1000c.

For example, the user may identify the XR image corresponding to the gaze of the robot 1000a remotely interacting via an external device, e.g., the XR device 1000c, and adjust the autonomous driving route of the robot 1000a, control operations or driving of the robot 1000a, or identify information about ambient objects via the interactions.

The autonomous vehicle 1000b may adopt AI technology XR technology and may be implemented as a mobile robot, vehicle, or unmanned aerial vehicle (UAV).

The XR technology-adopted autonomous vehicle 1000b may mean, e.g., an autonomous vehicle equipped with an XR image providing means or an autonomous vehicle targeted for control/interactions in the XR image. The autonomous vehicle 1000b targeted for control/interactions in the XR image may be distinguished from, and interact with, the XR device 1000c.

The autonomous vehicle 1000b equipped with the XR image providing means may obtain sensor information from sensors including a camera and output an XR image generated based on the obtained sensor information. For example, the autonomous vehicle 1000b may have an HUD and output an XR image, thereby providing an XR object corresponding to the real-world object or an object on screen to the passenger.

When the XR object is output on the HUD, at least part of the XR object may be output, overlaid on the real-world object the passenger's gaze is facing. In contrast, when the XR object is output on a display provided inside the autonomous vehicle 1000b, at least part of the XR object may be output, overlaid on the object on the screen. For example, the autonomous vehicle 1000b may output XR objects corresponding to such objects as lanes, other vehicles, traffic lights, traffic signs, motorcycles, pedestrians, or buildings.

When the autonomous vehicle 1000b targeted for control/interaction in the XR image obtains sensor information from sensors including a camera, the autonomous vehicle 1000b or the XR device 1000c may generate an XR image based on the sensor information, and the XR device 1000c may output the generated XR image. The autonomous vehicle 1000b may be operated based on the user's interactions or control signals received via an external device, e.g., the XR device 1000c.

Operation of the fire risk factor notifying device based on an IMS in an interior vehicle environment, configured as such, according to the present invention as configured above is described below in detail with reference to the accompanying drawings. The same reference numeral as that shown in FIG. 2 denote the same element performing the same function.

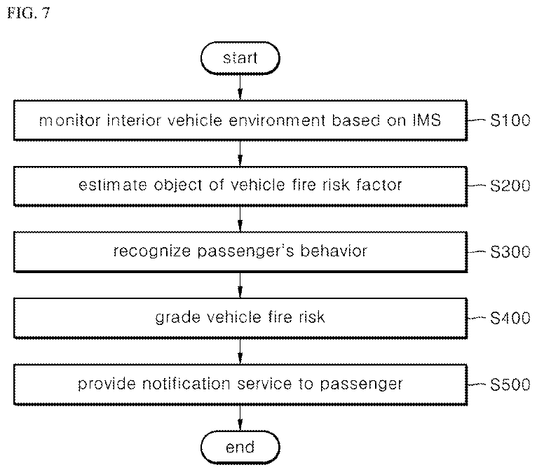

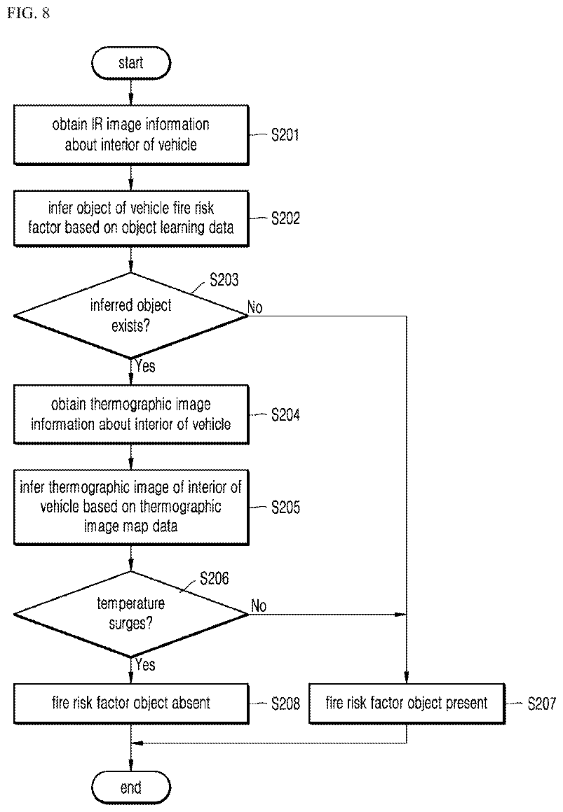

FIG. 7 is a flowchart illustrating a fire risk factor notifying method based on an IMS in an interior vehicle environment according to an embodiment of the present invention.

Referring to FIG. 7, the fire risk factor notifying device 100 monitors an interior vehicle environment obtained by the IMS 110 using the monitoring unit 120 (S100).

The obtained images may include infrared radiation (IR) images or thermographic images. The interior vehicle environment monitored may include first objects including electronic devices installed in the interior of the vehicle and things placed inside the vehicle and the movements, actions, or gestures of the passenger in the vehicle. The interior vehicle environment may also include a thermographic image map including the thermographic images of the interior of the vehicle.

Subsequently, the fire risk factor notifying device 100 recognizes a second object which may cause a vehicle fire based on the interior vehicle environment monitored by the monitoring unit 120 using the object recognizing unit 130 (S200). In other words, the object recognizing unit 130 may identify fire factors and risk types from among the first objects, thereby recognizing second objects which may cause a vehicle fire. The object recognizing unit may measure the temperature of the thermographic image based on the thermographic image map and recognize the presence or absence of a fire inside the vehicle.

The second objects may include electronic devices, e.g., a navigation and black box, installed in the interior of the vehicle, lighters, matches, or cigarettes.

Further, the object recognizing unit may recognize the second objects and the presence or absence of a fire based on object learning data and thermographic map learning data stored in the storage unit 150. The object learning data and the thermographic map learning data may be learned in an object model using deep neutral networks (DNN) training.

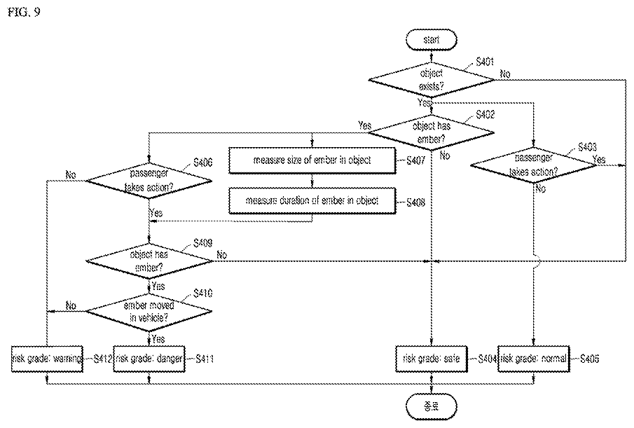

Step S200 of recognizing the second object and the presence or absence of a fire inside the vehicle is described below in greater detail with reference to FIG. 8.

Subsequently, the fire risk factor notifying device 100 recognizes the passenger's behavior based on the monitored interior vehicle environment using the behavior recognizing unit 140 and determines whether the passenger's behavior is related to the second object in association with the second object (S400). At this time, the behavior recognizing unit 140 may determine whether the passenger's behavior is related to the thermographic image map in association with the thermographic image map.

For example, if the passenger's behavior is moving the second object or removing the area of the thermographic image map, the behavior recognizing unit 140 determine that they are related to each other.

The fire risk factor notifying device 100 determines the risk grade of a vehicle fire using the grade determining unit 160 based on a combination of the second object and the presence or absence of a fire, which are recognized by the object recognizing unit 130, and the passenger's behavior recognized by the behavior recognizing unit 140 (S400). The risk grade may come in various levels, e.g., safe, normal, warning, and danger.

Step S400 of determining the risk grade of a vehicle fire is described below in greater detail with reference to FIG. 9.

Then, the fire risk factor notifying device 100 may transfer, as a notification service, the risk grade determined by the grade determining unit 160 to the passenger via a device capable of transferring visible or audible information in the vehicle using the notification processing unit 170 (S500). The device may include a display capable of transferring visible information and a speaker capable of transferring audible information.

Thus, the passenger may take a proper action according to the vehicle fire risk grade transferred via the device.

FIG. 8 is a detailed flowchart illustrating the step of recognizing the second object and the presence or absence of a fire inside the vehicle as shown in FIG. 7.

Referring to FIG. 8, the object recognizing unit 130 objects first objects including things placed inside the vehicle and electronic devices installed in the vehicle using the IR image of the interior of the vehicle monitored by the monitoring unit 120 (S201).

The object recognizing unit 130 compares the obtained first objects with object learning data stored in the storage unit 150, thereby inferring a second object corresponding to a vehicle fire risk factor (S202). The second object may correspond to a fire risk factor object model of the interior of the vehicle which is previously stored. For example, the second objects may include electronic devices, e.g., a navigation and black box, installed in the interior of the vehicle, lighters, matches, or cigarettes.

As a result of inferring a second object (S201), if there is no second object (S203), there is recognized to be no second object corresponding to a fire risk factor inside the vehicle (S207).

As a result of inferring a second object (S201), if there is a second object (S203), the object recognizing unit 130 obtains thermographic image information about the interior of the vehicle using the interior vehicle environment monitored by the monitoring unit 120 (S204). The thermographic image information may include a thermographic image map.

Subsequently, the object recognizing unit 130 compares the obtained thermographic image information with thermographic map learning data stored in the storage unit 150, thereby inferring a thermographic image for the interior of the vehicle (S205). As an example, the thermographic image map may include a thermographic image map produced from around the second object.

The object recognizing unit 130 measures the temperature of the inferred thermographic image and detects whether there is a portion where the measured temperature surges (S206). The temperature surge is assessed based on a standard curve which specifies temperatures over time in the atmosphere of the inside of a heating furnace in a fire-resistance or anti-fire test. In other words, if the temperature rising curve matches a standard fire temperature curve, there may be determined to be a temperature surge.

As a result of detecting a temperature surge (S206), unless there is a temperature surge, namely, if it is not shown as matching the standard fire temperature curve, there may be recognized to be no second object corresponding to a fire risk factor inside the vehicle (S207).

As a result of detecting a temperature surge (S206), if there is a temperature surge, namely, if it is shown as matching the standard fire temperature curve, there may be recognized to be a second object corresponding to a fire risk factor inside the vehicle (S207).

FIG. 9 is a detailed flowchart illustrating the step of determining the risk grade of a vehicle fire as shown in FIG. 7.

Referring to FIG. 9, the grade determining unit 160 determines whether a second object is recognized by the object recognizing unit 130 (first determination) (S401).

As a result of the first determination (S401), unless a second object is recognized, i.e., if there is determined to be no second object, the grade determining unit 160 may determine the vehicle fire grade as ‘safe’ (S404).

On the other hand, if a second object is recognized, i.e., there is determined to be a second object, by the object recognizing unit 130 as a result of the first determination (S401), the behavior recognizing unit 140 determines whether there is a first passenger behavior related to the second object (‘second determination’) (S403). The first passenger behavior may be an action corresponding to preventing a fire from the second object which is a fire risk factor. As an example, the first passenger behavior may include moving the second object or removing the area of the thermographic image map.

As a result of the second determination (S403), if there is determined to be no first passenger behavior, the grade determining unit 160 may determine the vehicle fire grade as ‘normal’ (S405).

As a result of the second determination (S403), if there is determined to be a first passenger behavior, the grade determining unit 160 may determine the vehicle fire grade as ‘safe’ (S404).

Additionally, if a second object is determined to be recognized, i.e., there is determined to be a second object as a result of the first determination (S401), the object recognizing unit 130 detects the presence or absence of an ember in the second object in the interior vehicle environment monitored by the monitoring unit 120 (first detection) (S409).

If the second object has no ember as a result of the first detection (S402), the grade determining unit 160 may determine the vehicle fire grade as ‘safe’ (S404). The vehicle fire grade set according to the second determination (S403) of the passenger behavior may be prioritized over the vehicle fire grade set according to the presence or absence of an ember. In other words, even when the second object has no ember, if there is determined to be no passenger behavior, the grade determining unit 160 may determine the vehicle fire grade as ‘normal.’ However, the present invention is not limited thereto, and the priority may be varied.

If the second object has an ember as a result of the first detection (S402), the behavior recognizing unit 140 determines whether there is a second passenger behavior related to the ember of the second object (‘third determination’) (S406). The second passenger behavior may be an action for removing the ember of the second object which is a fire risk factor. As an example, the second passenger behavior may include covering or hitting the ember with a hand or thing to put out the ember of the second object or removing the ember with water, beverage, or extinguisher.

As a result of the third determination (S406), if there is determined to be no second passenger behavior, the grade determining unit 160 may determine the vehicle fire grade as ‘warning’ (S412).

If there is determined to be a second passenger behavior as a result of the third determination (S406), it is determined whether the ember of the second object remains (fourth determination) (S409).

As a result of the fourth determination (S409), if the ember of the second object is determined to be not present, the grade determining unit 160 may determine the vehicle fire grade as ‘safe’ (S404).

Additionally, if the second object has an ember as a result of the first detection (S402), the object recognizing unit 130 measures the size of the ember of the second object in the interior vehicle environment monitored by the monitoring unit 120 (S407). The size of the ember may be the area of the ember positioned from the top to bottom of the second object and from the left to right of the second object.

The object recognizing unit 130 measures the duration of the ember of the second object (S408). The measurement of the duration of the ember of the second object may be performed during a pre-defined reference time. Preferably, the reference time may be within three seconds. As such, measuring the duration of the second object may prevent such an occasion where bright light is instantaneously reflected by the second object and this is determined to be an ember.

As a result of measuring the size of the ember during the duration (S408), it is determined whether the ember of the second object stays (fourth determination) (S409).

As a result of the fourth determination (S409), if the ember of the second object is determined to be not present, the grade determining unit 160 may determine the vehicle fire grade as ‘safe’ (S404). The vehicle fire grade set according to the third determination (S406) of the passenger behavior may be prioritized over the vehicle fire grade set according to the result of measurement during the duration of the ember (S408). In other words, when the second object has an ember but there is determined to be no passenger behavior, the grade determining unit 160 may determine the vehicle fire grade as ‘warning’ regardless of the size of the ember of the second object and the duration of the ember. However, the present invention is not limited thereto, and the priority may be varied.

If the ember is determined to stay on the second object as a result of the fourth determination (S409), it is determined whether the ember of the second object is moved to a place around the second object (fifth determination) (S410). The fifth determination may be performed based on the size of the ember of the second object which is measured by the object recognizing unit 130. For example, if the size of the ember departs from a reference range for the second object, the ember may be determined to have been moved to a place around the second object. The reference range may be defined as a range in which the area of the ember positioned from the top to bottom and left to right of the object becomes 1.5 times the size of the object.

If the ember of the second object is determined to have been moved to a place around the second object as a result of the fifth determination (S410), the grade determining unit 160 may determine the vehicle fire grade as ‘danger’ (S411).

Unless the ember of the second object is determined to have been moved to a place around the second object as a result of the fifth determination (S410), the grade determining unit 160 may determine the vehicle fire grade as ‘warning’ (S412).

While the present invention has been shown and described with reference to exemplary embodiments thereof, it will be apparent to those of ordinary skill in the art that various changes in form and detail may be made thereto without departing from the spirit and scope of the present invention as defined by the following claims. Further, although operations and effects according to the configuration of the present invention are not explicitly described in the foregoing detailed description of embodiments, it is apparent that any effects predictable by the configuration also belong to the scope of the present invention.

[Description of Denotations]

| | |
|---|---|
| 100: fire risk factor notifying device | 110: IMS |
| 120: monitoring unit | 130: object recognizing unit |
| 140: behavior recognizing unit | 150: storage unit |
| 160: grade determining unit | 170: notification processing unit |

What is claimed is:

1. A fire risk factor notifying device, comprising:
a monitoring unit monitoring an interior environment of a vehicle based on an image obtained from an interior monitoring sensor (IMS);
an object recognizing unit recognizing a second object which may cause a vehicle fire from among first objects monitored in the interior vehicle environment, the second object identified based on object learning data;
a behavior recognizing unit recognizing a passenger's behavior monitored in the interior vehicle environment;
a grade determining unit determining a risk grade of a vehicle fire based on a combination of the second object and the passenger's behavior; and
a notification processing unit transferring the determined risk grade to the passenger via a device capable of transferring visible or audible information in the vehicle.

2. The fire risk factor notifying device of claim 1, wherein the object recognizing unit measures the temperature of a thermographic image based on a thermographic image map monitored in the interior vehicle environment.

3. The fire risk factor notifying device of claim 2, wherein the behavior recognizing unit determines whether the passenger behavior recognized by the behavior recognizing unit is related to the second object and the thermographic image map in association with the second object and the thermographic image map.

4. The fire risk factor notifying device of claim 1, wherein the image includes an infrared radiation (IR) image and a thermographic image.

5. The fire risk factor notifying device of claim 1, wherein the interior vehicle environment includes the first objects including an electronic device installed in the vehicle and things placed in the vehicle, the passenger behavior including a movement, motion, and gesture of the passenger in the vehicle, and a thermographic image map including a thermographic image map of an interior of the vehicle.

6. A fire risk factor notifying method, comprising:
monitoring an interior environment of a vehicle based on an image obtained by an interior monitoring sensor (IMS) using a monitoring unit;
recognizing, using an object recognizing unit, a second object which may cause a vehicle fire from among first objects monitored in the interior vehicle environment, the second object identified based on object learning data;
recognizing, using a behavior recognizing unit, a passenger behavior based on the monitored interior vehicle environment;
determining, using a grade determining unit, a risk grade of a vehicle fire based on a combination of the second object and the passenger's behavior; and
transferring, using a notification processing unit, the determined risk grade to the passenger via a device capable of transferring visible or audible information in the vehicle.

7. The fire risk factor notifying method of claim 6, wherein recognizing the second object includes obtaining the first objects including an electronic device installed in the vehicle and a thing placed in the vehicle using IR image information about the monitored interior of the vehicle, comparing the first objects with stored object learning data to infer a second object corresponding to a vehicle fire risk factor, as a result of the inference, if there is no second object, recognizing that there is no second object corresponding to a fire risk factor inside the vehicle, and as a result of the inference, if there is a second object, recognizing that there is a second object corresponding to a fire risk factor inside the vehicle.

8. The fire risk factor notifying method of claim 7, further comprising:
if there is a second object as a result of the inference, obtain thermographic image information about the interior of the vehicle using the monitored interior vehicle environment;
comparing the thermographic image information with stored thermographic map learning data to infer a thermographic image of the interior of the vehicle;
measuring a temperature of the inferred thermographic image and detecting whether the measured temperature rises along a standard fire temperature curve;
if the temperature does not rise along the standard fire temperature curve as a result of the detection, recognizing that there is no second object corresponding to a fire risk factor inside the vehicle; and
if the temperature rises along the standard fire temperature curve as a result of the detection, recognizing that there is a second object corresponding to a fire risk factor inside the vehicle.

9. The fire risk factor notifying method of claim 6, wherein determining the risk grade of the vehicle fire includes first determining whether a second object is recognized by an object recognizing unit, if no second object is recognized as a result of the first determination, determining a vehicle fire grade as safe using a grade determining unit, if a second object is recognized as a result of the first determination, second determining whether there is a first passenger behavior related to the second object using a behavior recognizing unit, if there is determined to be no first passenger behavior as a result of the second determination, determining the vehicle fire grade as normal using the grade determining unit, and if there is determined to be a first passenger behavior as a result of the second determination, determining the vehicle fire grade as safe using the grade determining unit.

10. The fire risk factor notifying method of claim 9, wherein the first passenger behavior includes an action corresponding to preventing a fire from the second object which is a fire risk factor.

11. The fire risk factor notifying method of claim 9, further comprising:
if the second object is recognized as a result of the first determination, first detecting whether the second object has an ember in the monitored interior vehicle environment using an object recognizing unit;
if the second object has no ember as a result of the first detection, determining the vehicle fire grade as safe using the grade determining unit;
if the second object has an ember as a result of the first detection, third determining whether there is a second passenger behavior related to the ember of the second object;
if there is determined to be no second passenger behavior as a result of the third determination, determining the vehicle fire grade as warning using the grade determining unit;
if there is determined to be a second passenger behavior as a result of the third determination, fourth determining whether the ember of the second object remains;
if the ember of the second object does not remain as a result of the fourth determination, determining the vehicle fire grade as safe using the grade determining unit;
if the ember is determined to remain on the second object as a result of the fourth determination, fifth determining whether the ember of the second object is moved to a place around the second object;
if the ember of the second object is determined to be moved to the place around the second object as a result of the fifth determination, determining the vehicle fire grade as danger using the grade determining unit; and
if the ember of the second object is determined to be not moved to the place around the second object as a result of the fifth determination, determining the vehicle fire grade as warning using the grade determining unit.

12. The fire risk factor notifying method of claim 9, wherein the vehicle fire grade set according to the second determination of the passenger behavior is prioritized over the vehicle fire grade set according to the presence or absence of the ember.

13. The fire risk factor notifying method of claim 11, wherein the second passenger behavior includes an action for removing the ember of the second object which is a fire risk factor.

14. The fire risk factor notifying method of claim 11, further comprising:
if the second object has an ember as a result of the first detection, measuring a size of the ember of the second object in the monitored interior vehicle environment using an object recognizing unit;
measuring duration of the ember of the second object using the object recognizing unit; and
performing the fourth determination according to a result of measuring the size of the ember during the duration of the ember.

15. The fire risk factor notifying method of claim 14, wherein if the ember is not present in the second object, the vehicle fire grade set according to the third determination of the passenger behavior is prioritized over the vehicle fire grade set by a result of measurement during the duration of the ember.

16. The fire risk factor notifying method of claim 11, wherein the fifth determination is performed based on the size of the ember of the second object measured by the object recognizing unit.

17. The fire risk factor notifying method of claim 6, wherein recognizing the second object includes measuring the temperature of a thermographic image based on a thermographic image map monitored in the interior vehicle environment.

18. The fire risk factor notifying method of claim 17, wherein the behavior recognizing unit determines whether the passenger behavior is related to the second object and the thermographic image map in association with the second object and the thermographic image map.

19. The fire risk factor notifying method of claim 6, wherein the image includes an infrared radiation (IR) image and a thermographic image.

20. The fire risk factor notifying method of claim 6, wherein the interior vehicle environment includes the first objects including an electronic device installed in the vehicle and things placed in the vehicle, the passenger behavior including a movement, motion, and gesture of the passenger in the vehicle, and a thermographic image map including a thermographic image map of an interior of the vehicle.
